(19) United States
(12) Patent Application Publication
(10) Pub. No.: US 2017/0248284 A1
(43) Pub. Date: Aug. 31, 2017

(54) MODULAR LIGHTING ARRAY

(71) Applicant: Christina BALDWIN, Carol Stream, IL (US)

(72) Inventor: Christina BALDWIN, Carol Stream, IL (US)

(21) Appl. No.: 15/053,366

(22) Filed: Feb. 25, 2016

(51) Int. Cl. F21S 4/15; F21V 21/08

(52) U.S. Cl. CPC F21S 4/15; F21V 21/08; F21W 2121/04

(57) ABSTRACT

A lighting system comprising of a plurality of lights situated on one or more detachably connectable, modular, lighting panels.

### FIELD OF THE INVENTION

The present invention relates to a lighting array and more particularly to a decorative modular lighting array that is for both indoor and outdoor use.

### BACKGROUND OF THE INVENTION

Decorative lighting assemblies, such as strands and sheets of interconnected lights, be they strands of light bulbs or LED fixtures or the like, are well known for both indoor and outdoor decoration, especially for Christmas tree decorations. Outdoor decorative lighting assemblies are oftentimes much larger than indoor ones and much larger spaces may need to be decorated. Notwithstanding, whether for indoor or outdoor use, the decorative assembly must be structurally robust enough to meet safety requirements, including materials, electrical wirings and connections, which requirements increase as to size. Still, whether indoor or outdoor use is contemplated, the very nature of applying an electrical array of lighting materials containing many electrical wirings and connections usually makes assembly, such as on a Christmas tree, challenging, and time consuming and more so for larger outdoor displays, oftentimes becoming excessively expensive, especially when maintenance is considered. Removal and storage can also become problematic. There is, therefore, a need to provide an improved indoor or outdoor decorative lighting assembly to overcome these afore-mentioned disadvantages of conventional lighting materials, such as strand and sheet lighting.

### SUMMARY OF INVENTION

In accordance with the invention in its broadest sense, there is provided a decorative lighting array which comprises one or more modular, inter-connectable panels, each shaped such as to conform to and cover an intended geometric shape, either alone or when interconnected together, or at least partially cover such intended geometric shape.

This invention will be more fully understood from the following detailed description of preferred embodiments with reference to drawings and examples, all of which are intended to be for illustrative purposes only, and are not intended in any way to limit the scope or spirit of the claims of this invention.

### BRIEF DESCRIPTION OF THE DRAWINGS

FIG. 1 is an illustrative frontal plan view of an embodiment of a modular panel of an inventive, decorative lighting array shaped to conform to a section of a Christmas tree periphery.

FIG. 2 is an illustrative frontal plan view of a plurality of modular panels of an inventive, decorative lighting array of FIG 1, inter-connected to be applied to at least a portion of a Christmas tree shaped periphery.

FIG. 3 is an elevational perspective view of inter-connected modular panels of FIG. 2 as applied to a portion of the periphery of a Christmas tree.

DETAILED DESCRIPTION OF THE INVENTION

All patent references, published patent applications, and literature references referred to or cited herein are expressly incorporated by reference to the same extent as if each were specifically and individually indicated to be incorporated by reference. Any inconsistency between these publications and the present disclosure is intended to and shall be resolved in favor of the present disclosure.

As set forth above, it its broadest sense, the present invention provides a decorative lighting array which comprises one or more or a plurality of modular inter-connectable panels with each shaped such as to conform to and cover an intended geometric shape, either alone or when inter-connected together, or at least partially cover such intended geometric shape.

The term “decorative” as used herein is not in any way intended to be limiting, as it is contemplated that modular lighting array panels of the invention may also function as visual lighting aids or fixtures much in the same way in the use of a lamp or other visual lighting aid.

Geometric shapes encompassed by the invention are only those limited by one's imagination, and by way of example may include, without limitation, both 2-dimentional and 3-dimentional geometric surfaces and shapes, asymmetrical and non-uniform, and disproportional shapes without limitation, such as, for example: frustoconical, elliptical, oblong, ovate, oval, ovoid, pear-shaped, egg-shaped, stadium shaped, ellipsoidal, elongated, cylindrical, ovaloid, oviform, round, global, globular, triangular, square, parallelogram, rhombus, trapezoid, trapezium, kite-shaped, quadrilateral, irregular quadrilateral, polygonal, lens-shaped, crescent, arch-shaped, annulus, cube, hexahedron, prism, cuboid, cone-shaped, hexagonal prism, pentagonal prism, pyramidal, including square, triangular, and hexagonal pyramids, parallelepiped, tetrahedron, octahedron, dodecahedron, icosahedron, rhombic dodecahedron, frustum, folium, teardrop, kidney, heart, nephroid, cinquefoil, trefoil, quatrefoil, dome, barrel, torus, humanoid, and animal shapes, such as the peripheries or partial peripheries of various characters, human, animal, or marine.

Any type of lighting elements, wiring, circuitry and the like designed and adopted for use indoors and/or outdoors e contemplated for use in this invention. These would include, without limitation, well known C7 and C9 Christmas lights (2″ and 3″ long, respectively), LED lights, incandescent lights, and solar activated lights, each of which can be chosen for requirements best suited as well known in the art. Any type of electrical connectors, co-connectors, or jacks are contemplated for use herein.

The degree of dimensional spacing of lights herein from one another is not critical to this invention, and may also be chosen as best suited for an application as well known in the art, such as the degree of lighting coverage required or contemplated, and other factors such as the expanse contemplated, and/or if used as a visual light aid or a visual lighting aid in combination as decorative lighting.

A modular panel or panels may be fabricated with different accoutrements, equipment, paraphernalia, or apparatus and the like, depending upon, for example, the theme, such as a contemplated holiday. For example, for Christmas or holiday seasons, a star or angel may be attached to the top of a modular panel. For other holidays, such as St. Patrick's Day, a four-leaf clover or shamrock shaped device may be attached to a modular panel, or something for Valentine's Day, or for a Jewish holiday symbol such as the Star of David or a menorah device may be employed, or functional devices such as ground attachments.

Each of the individual interconnected modular panels may be detachably interconnected by any known means, such as a male/female socket clasp, Velcro strips, mechanical twists and the like.

### EXAMPLES OF PREFERRED EMBODIMENTS

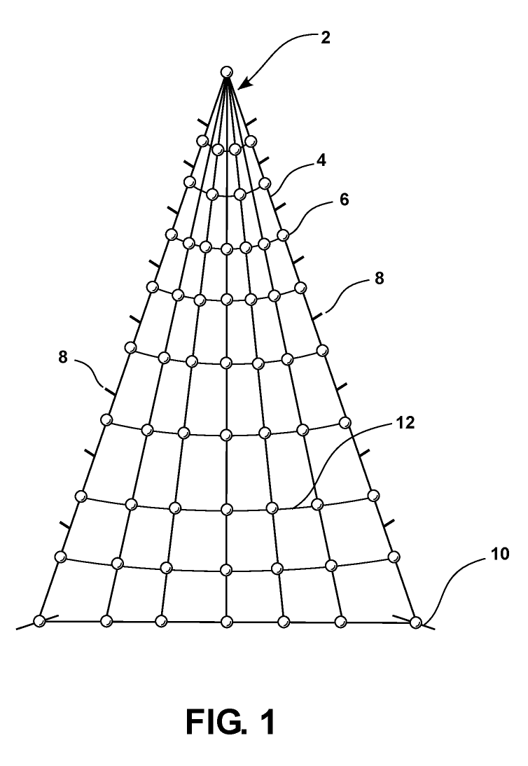

As shown in FIG. 1, there is illustrated a frontal plan view of an embodiment of a modular panel of the invention as a decorative lighting array shaped to conform to a section of a Christmas tree periphery. The lighting array panel 2 is composed of a plurality of strands 4, such as manufactured from standard Christmas lighting strands with lights 6 attached at desired intervals or spacing to provide a desired or contemplated lighting density per panel space. Outer strands 4 are equipped with detachable connectors 8 to detachably connect to other panels as desired. In this example embodiment, there is also provided optional base attachments 10. Interconnecting strands 12 may preferably be of a curved shape to conform to the approximate symmetry of the periphery of a covered or partially covered geometric shape, and may, for example, be of an asymmetrical camber shape to approximately conform to an asymmetrical shape contemplated to be covered or at least partially covered.

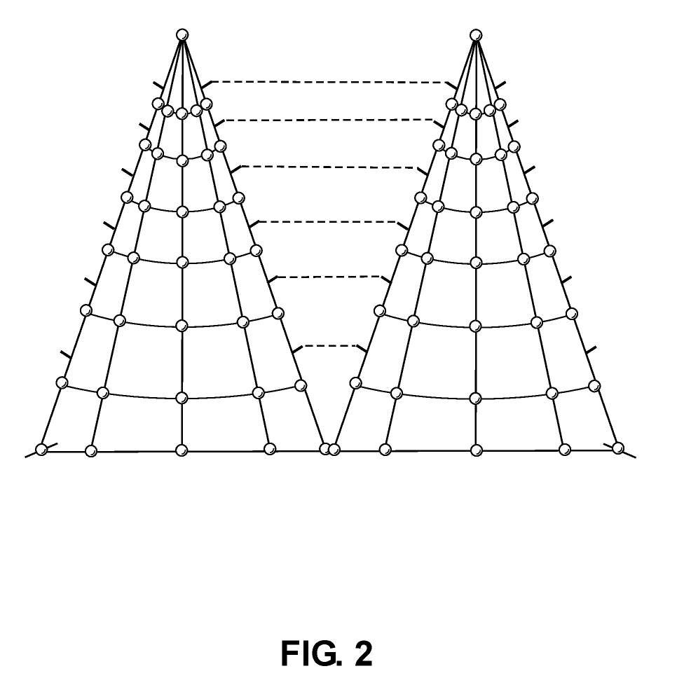

Turning to FIG. 2, there is illustrated a frontal plan view of a plurality of modular panels of an inventive, decorative lighting array as shown in FIG. 1 and inter-connectable to be applied to at least a portion of a Christmas tree shaped periphery.

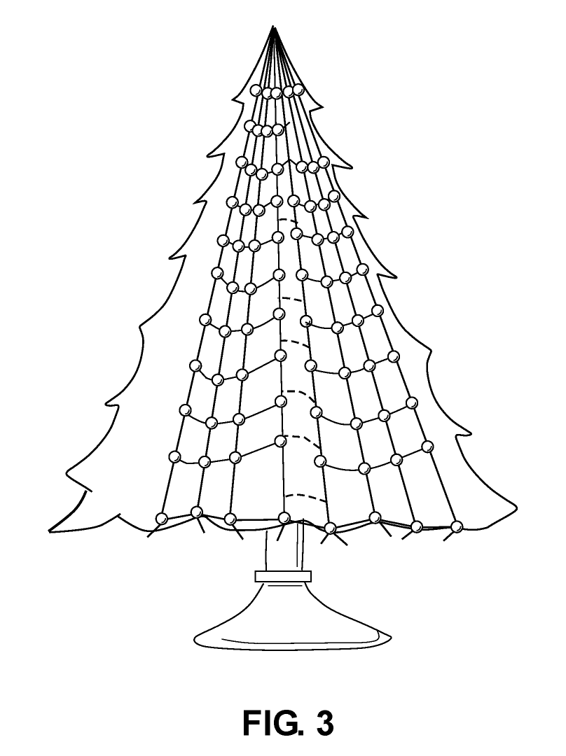

As shown in FIG. 3, there is provided an elevational perspective view of the plurality of modular panels of FIG. 3 as applied to a portion of the Christmas tree.

While this invention has been described in conjunction with illustrative examples of some preferred embodiments, it is intended so as not to be constructed as so limited, as one skilled in the art will be able to utilize and employ substitutes and equivalents thereof without departing from the scope and bounds of the invention and the spirit thereof.

What is claimed is:

1. A lighting system comprising of a plurality of lights situated on one or more detachably connectable, modular, lighting panels:

2. The system of claim 1 wherein one or more a said one or more modular panels can be detachably connected to cover the outer periphery of a geometric shape.

3. The system of claim 2 wherein the geometric shape is selected from the group comprising of 2-dimensional shapes, 3-dimensional shapes, asymmetrical shapes, and non-uniform shapes.

4. The system of claim 2 wherein the geometric shape is selected from the group consisting of frustoconical, elliptical, oblong, ovate, oval, ovoid, pear-shaped, egg-shaped, stadium shaped, ellipsoidal, elongated, cylindrical, ovaloid, oviform, round, global, globular, triangular, square, parallelogram, rhombus, trapezoid, trapezium, kite-shaped, quadrilateral, irregular quadrilateral, polygonal, lens-shaped, crescent, arch-shaped, annulus, cube, hexahedron, prism, cuboid, cone-shaped, hexagonal prism, pentagonal prism, pyramidal, including square, triangular, and hexagonal pyramids, parallelepiped, tetrahedron, octahedron, dodecahedron, icosahedron, rhombic dodecahedron, frustum, folium, teardrop, kidney, heart, nephroid, cinquefoil, trefoil, quatrefoil, dome, barrel, torus, humanoid, and animal shapes, such as the peripheries or partial peripheries of various characters, human, animal, or marine.

5. The system of claim 2 wherein the geometric shape is a Christmas tree shape.

6. The system of claim 2 wherein the bottom portion a modular panel comprises of tie-downs or hold-downs for holding the module in place as desired.

7. A method of covering a portion of a geometrically shaped object by applying to at least a portion of the object a lighting system comprising of a plurality of lights situated on one or more detachably connectable modular lighting panels.

8. The method of claim 7 wherein the object is Christmas tree shaped.
